(19) United States
(12) Patent Application Publication
(10) Pub. No.: US 2009/0205379 A1
(43) Pub. Date: Aug. 20, 2009

(54) Wristraint Flexible Handcuff

(76) Inventor: Danny Alan Williams, Aurora, CO (US)

Correspondence Address: Danny Williams, 12695 E. 14th Ave., Aurora, CO, 80011, US

(21) Appl. No.: 12/317,397

(22) Filed: Dec. 22, 2008

Related U.S. Application Data
(60) Provisional application No. 61/009,084, filed on Dec. 27, 2007.

(51) Int. Cl. E05B 75/00

(52) U.S. Cl. 70/16

(57) ABSTRACT

A flexible Nylon devise that makes an adjustable loop used to restrain a person. The devise is comprised of two straps and a center double O connector. The straps have teeth on one side and are smooth on the other. There is a lock housing on one end and the other is tapered for easy insertion. The double O connector is placed with each of the two straps inserting into one side of the connector. The tapered end is inserted into the open end of the lock then slides into lock forming a loop. As the strap travels through the housing it encounters a set of pawls on the base of the lock. The strap is now locked. Repeat the step, you now have a set of Flexible handcuffs. To release insert a universal Handcuff key turn counter clockwise one sixteenth of an inch 7 degrees to open.

### BACKGROUND OF INVENTION

The use of flexible straps to secure bundles of wire or cable is well known along with it use by Law Enforcement Military and Professional Security. Typical devices using this concept consist of an elongated strap with a lock on one end. The strap is placed around the wrist of the person to be secured, and then the free end of the strap is drawn through the lock and the loop is tightened. The lock generally includes a ratchet arrangement that engages a set of teeth, grooves or holes on the free end of the strap. The loop is made tight by drawing the free end of the strap through the locking devise. The ratchet with the teeth maintains the tightened condition. Such devices are commonly referred to as “cable ties”. Cable ties have been used by a number of Law Enforcement agencies for quite a numbers of years. This was due to the lightweight and ease of use. Distinct advantages for securing large numbers of people quickly, cost wise, availability made the (Cable ties ) a very popular piece of equipment for L.E. ( law enforcement ) Military and all types of Security Professionals. The downside to the use of cable ties is that they are generally small in diameter, low tensile strength and can only be used once. they are also susceptible to cause injury to the person being restrained. environmentally: Cable ties normally once used are thrown into the trash and end up in landfills where they will stay for a very long time. Because of our design these devices rarely were out and those that do are recycled when returned to the company of origin. One of the chief advantages of the device over cable ties and other devices for securing suspects is its reusable. Another advantage is its also very strong and extremely hard to circumvent. An officer can simply pull the free end of the strap tightly through the lock on the other end to diminish the loop size. As he or she does so, the ratchet in the lock ratchets through the teeth or serrations in the free end. When the free end is let loose, it cannot back out of the lock and thereby expand the size of the loop by more than the small distance between adjacent teeth or serrations which is generally less than a tenth of an inch. It has been known for some time that cable ties and similar devices employing flexible straps that a re adjustably looped into locks that use one-way ratchets, could be used as cuffs to restrain a person. The simplest way to restrain a person using a cable tie is to loop a single cable tie around the person's wrists and tighten the loops so that the wrists are bound together. This is particularly effective if the person's hands are behind his back. Additional restrain can be established by looping another cable tie around the person's ankles and tightening that loop to bind the ankles together. Law enforcement authorities have used cable ties for this purpose for a number of years in place of traditional metal handcuffs, because in comparison to metal handcuffs, cable ties are lightweight and compact. Also, a danger of metal handcuffs is that the person to be restrained may break free after one cuff is on but before the second cuff is on, and then the free cuff becomes a deadly swinging weapon. Devices have also been developed which operate on the basic idea of a free strap looped into a ratchet lock, but which are specifically configured for restraining a person rather than for bundling wire or cable. For example, U.S. Pat. No. 4,071,023 by Gregory is a restraining cuff with two free straps and two ratchet locks, so that there is a separate cuff for each of two wrists or there are two free straps and two ratchet locks so that two cuffs can be formed, but the two locks are positioned on a single mount. U.S. Pat. No. 5,099,662 by Tsai includes a mechanism to release the two ankles. U.S. Pat. No. 5,088,148 by Burkholder is similar to the Gregory patent in that ratchet to allow the device to be re-used. U.S. Pat. No. 4,964,419 by Karriker includes a mechanism to expand and contract the cuff size. U.S. Pat No. 5,377,510 Jan. 3, 1995 by Smith his product know as key-cuff also included a mechanism that was released by a regular handcuff key and was and still are being used by the Military in foreign countries. The drawback to these restraint devices is if they are not assembled correctly they can be easily compromised and they are not wearer friendly and can cause injury and or irritation to any exposed skin. A significant drawback to the use of ordinary cable ties as restraining devices is that most of them can be used only once. After the free end of the strap is looped into the ratchet lock, it is impossible to draw it back out. Therefore, it is necessary to cut the strap with a pair of wire cutters or a similar tool when the restrained person is to be freed. In fact, it is necessary to cut the strap and apply another cable tie if the person is not to be freed but merely because the loop was too tight on the person. Of course, this destroys the cable tie. There are a few devices that are re-usable such as the Karriker devices mentioned above. However, a drawback to those devices is that they are designed such that the lock can be released without the use of a key so that the restrained person himself or someone else without authority can release them. Also in the prior art are ordinary cable ties not specifically designed to restrain a person, that have a tab protruding out of the ratchet lock to disengage a ratchet pawl from teeth on the strap to release the strap. Such devices have the same limitations as the Karriker device in that there is nothing to prevent unauthorized persons from releasing the device. The device mentioned above is released using a key; however, unlike the present invention, that device is quite complex in its mechanism.

### BRIEF DESCRIPTION OF THE DRAWINGS

### COVER PAGE Product Picture

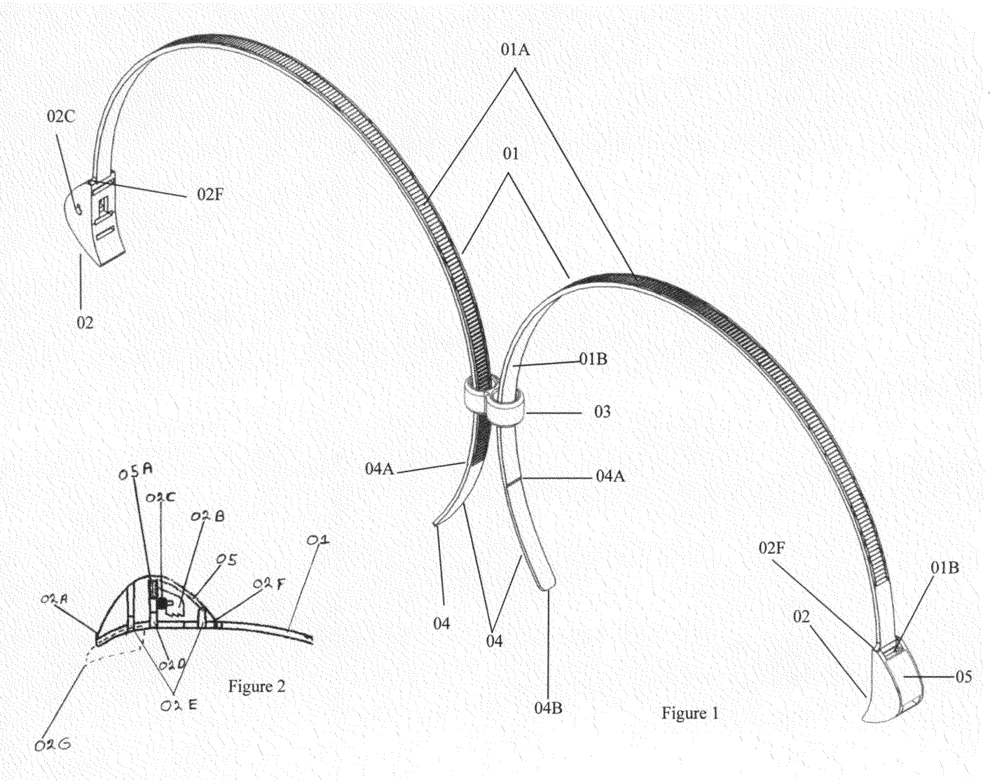

FIG. 1 is a pictorial view of the present invention, with the free end of the strap looped into the connecting rings

FIG. 2 is a perspective view showing the lock of the present invention in detail.

FIG. 3 is a sectional view of the lock of the present invention, without the free end of the strap being inserted into the locking mechanism.

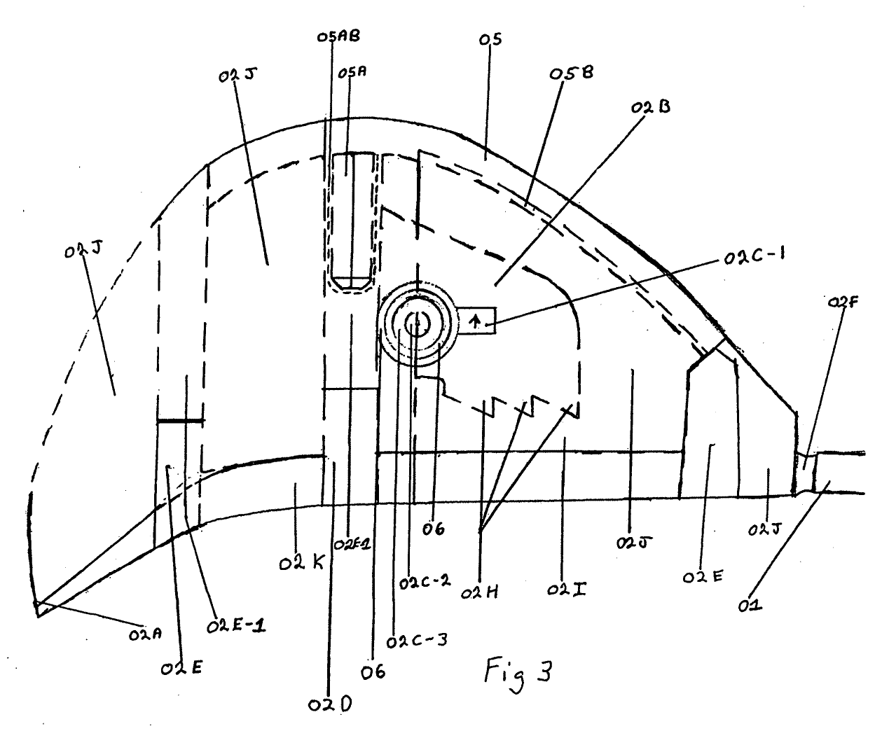

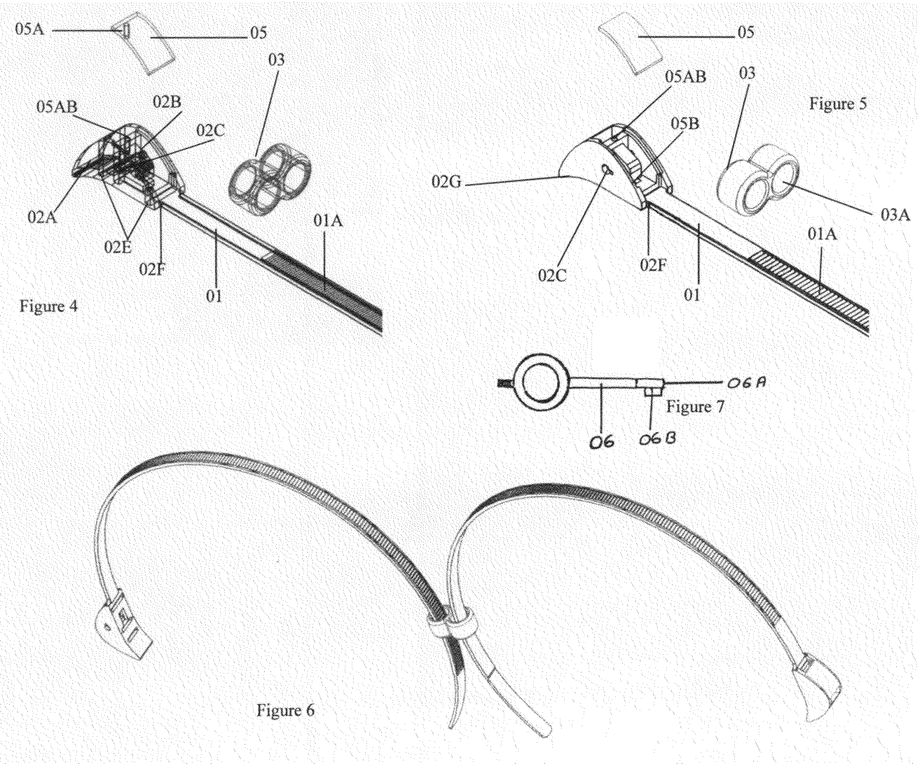

FIG. 4 is a sectional view of the lock of the present invention, with the free end of he strap cropped.

FIG. 5 is a open view of the ratchet arm exposed with cover cap and connecting rings.

FIG. 6 is the complete set view.

FIG. 7 is a common handcuff key.

### DETAILED DESCRIPTION OF THE INVENTION

A Designers view of the invention in FIG. 6 and in FIG. 1 shows a complete set unfastened. The main components of the device are comprised of the Main Body Strap FIG. 1-01 and the Locking mechanism on one end of the main body FIG. 3. (in greater detail described further on.). The free end or the (Nose) FIG. 1-04B is rounded and tapers down a couple of inches back from the nose to about 75% of the strap body for easy insertion into the locking Mechanism Housing FIG. 3. Also noted the Ratchet Teeth FIG. 1-01A on the opposite side of the tapered end. The smooth side of the main body FIG. 1-01B is the inside of the loop when fastened, as are the teeth FIG. 1-01A are on the outside of the loop when fastened. This results in less discomfort to an individual. The locking Mechanism and Housing is shown in enlarged detail in FIG. 3. The Strap Feed End FIG. 1-04 is placed into the Feed Ramp FIG. 3-02A. The end then proceeds through the strap trough FIG. 3-21, as it passes through the trough it's guided under the Ratchet Arm FIG. 3-02B and out the end now over lapping the main body strap neck FIG. 3-2F. The housing of the lock FIG. 3-02J is rounded on top and curved underneath and is about 1½ inches in length. It has two upper housing supports FIG. 3-02E-1, and three lower trough support columns two outer and one center FIG. 3-02E, Center column FIG. 2-02D. The top of the Locking Mechanism Housing is open FIG. 5 and shows the upper Housing support columns FIG. 3-02E-1 and the Ratchet Arm FIG. 3-02B. At the top of the center support FIG. 5-05AB is the Dowel Insert Cavity for the Cover Cap Dowel FIG. 3-5A. The Cover Cap FIG. 1-05, FIG. 3-05, FIG. 4-05 and FIG. 5-05 sits in a step FIG. 5-05B and the Cover Cap Dowel FIG. 3-5A inserts into the Dowel Insert Cavity FIG. 5-05AB for a tight fit on top of the Locking Mechanism Housing. This seals off any easy access to the Ratchet Arm Teeth FIG. 3-02H these teeth and Ratchet Arm FIG. 3-02B, the main locking components. The Key FIG. 7-06 inserts into the Key Port FIG. 4-02C, the key is then rotated counter clockwise which raises the Ratchet Arm FIG. 3-02B that in turn releases the Main Body Teeth FIG. 1-01A The key has a paddle on one end FIG. 7-06B that sits inside the Ratchet Arm FIG. 3-02C-1 and hollowed end or (Key Barrel) FIG. 7-06A that when inserted into the Key Port FIG. 5-02C. The Key Barrel fits over an axle (Key Barrel Axle) FIG. 3-02C-2 this axle allows for maximum leverage against the Ratchet Arm FIG. 3-02C-1. FIG. 3-02C-3 shows the outside diameter of the Key Barrel Axle. The final structural component of the Locking Mechanism Housing is the Bottom Plate component FIG. 3-02K. The Bottom Plate is thick below the Ratchet arm area and has a curvature FIG. 2-02G on the Feed Ramp end FIG. 3 that tapers upward as it gets further into the base of the housing. The curvature is approximately the same as the curvature of most human wrists. The component devise that connects tow or more Main Body Straps is the Double O connector FIG. 1-03. The Double O connector has two ports FIG. 1-03A that will accommodate the strap twice as when in use the Strap End sticking out of the Locking Mechanism Housing is then looped through the Double O connector in the same Strap Port of each strap. Unlike regular metal hand cuffs that are carried in a pouch or pocket or laid over a belt these restraint devices are lighter, are usually worn on the arm of the arresting party. This allows the arresting party hold and individual by the wrist or hand as they are easily slipped over the wrist of the individual.

What is claimed is:

1. The Devise of claim 1: A key-release restraining devise, comprising a strong flexible strap having a lock integral with the strap and located on one end of the strap, a free end opposite the end of the lock for insertion into the lock to form an adjustable loop and a set of strap teeth spaced along the outside of the strap to prevent undue injury to the person or persons being restrained. The lock including a cavity through which the strap passes, the cavity being bounded by a wall on one side to receive the strap and a ratchet mounting wall on the opposite side, the lock further including a one-way ratchet integrally formed with the lock having a spaced apart from the hinge, extending from the hinge end of the body to the ratchet-mounting wall. A set of ratchet teeth normally engaging the strap teeth to allow the strap teeth to pass the ratchet teeth in a first direction as the strap is inserted into the lock but not in a second direction opposite the first direction when the strap is urged out of the lock: a key-operated release to disengage the ratchet teeth from the strap teeth to allow the strap teeth to pass the ratchet teeth in said second direction to allow the strap to be withdrawn from the ratchet. The ratchet release including a horizontal keyhole to receive a key, the keyhole having a hole portion to receive a barrel of a key, a slot portion to receive the tab of the key and a axle inside the keyhole for proper alignment and leverage. The keyhole being positioned horizontally is such that the insertion of the key allows maximum leverage and the subsequent counter clockwise rotation of the key causes the tab to apply a against the hinge end of the ratchet body to rotate the ratchet about the hinge to disengage the ratchet teeth from the strap teeth to allow the strap to be withdrawn from the lock. The devise can be placed on the wrist, ankles or can be configured as a restraining harness. A harness for the waist or body. Thus they are lighter, very strong and not able to rust.

2. The devise of claim 2: the carrier of the locking mechanism is an enclosure that incorporates a single point cover which protects the locking mechanism from being easily breached.

3. The devise of claim 3: Further comprising most handcuff keys are able to unlock said locking devise.

4. The devise of claim 4: Wherein the keyhole includes a pin co-axle within the inset portion and the key includes a hole co-axle with a barrel to receive said axle when the key is inserted into the keyhole.

5. The devise of claim 5: the strength is of a combination Nylon and Design.
